(19) United States
(12) Patent Application Publication
(10) Pub. No.: US 2007/0300312 A1
(43) Pub. Date: Dec. 27, 2007

(54) User presence detection for altering operation of a computing system

(75) Inventors: Behrooz Chitsaz, Bellevue, WA (US); Darko Kirovski, Kirkland, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/472,575

(22) Filed: Jun. 22, 2006

(51) Int. Cl. G06F 11/00

(52) U.S. Cl. 726/34

(57) ABSTRACT

Various technologies and techniques are disclosed that modify a computer system based on user presence detection. An input device detects whether a user is present and adjusts the operation of an application accordingly. For example, ports or services can be disabled to increase security, a logging operation can be increased, a port or service that was previously disabled can be enabled, at least one system feature based on a number of users present can be adjusted, etc. If the user is detected to be absent, for example, then the system can disable at least one system port or service that does not need to be enabled while the user is absent to increase the security state of the computer. An attack directory can be accessed to retrieve information about the most likely services to be attacked, and that information can be used to help determine what services to disable.

### BACKGROUND

In many cases, personal computers are powered up for continuous, long periods of time while users typically use them during a small fraction of the power-on time. Applications such as voice-over-IP, peer-to-peer networking, networked video games, and messaging require incoming traffic into a personal computer in order to provide their services. Since firewalls are not impenetrable, such traffic is cause to most system vulnerabilities. Attacks are usually launched by scanning through series of active IP addresses, and the more that incoming traffic is allowed on a given computer, the more likely it is that the computer will be attacked.

### SUMMARY

Various technologies and techniques are disclosed that modify a status of a computer system based on user presence detection. One or more input devices (such as a keyboard, mouse, camera, etc.) detect whether a user is present. The operation of an application is adjusted based on whether or not the user is present. As a few non-limiting examples, services can be disabled to increase security, a logging operation can be increased, a service that was previously disabled can be enabled, at least one system feature based on a number of users present can be adjusted, etc. In one implementation, if the user is detected to be absent, then the system disables at least one system service that does not need to be enabled while the user is absent to increase the security state of the computer. In another implementation, an attack directory is accessed to retrieve information about the most likely services to be attacked, and that information is used to help determine what services to disable to increase the security of the computer system.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a user presence detection application of one implementation operating on the computer system of FIG. 1.

FIG. 3 is a process flow diagram for one implementation of the system of FIG. 1 illustrating the stages involved in detecting the presence or absence of one or more users and adjusting the security and/or other system features accordingly.

FIG. 4 is a process flow diagram for one implementation of the system of FIG. 1 illustrating the stages involved in detecting the presence or absence of one or more users.

FIG. 5 is a process flow diagram for one implementation of the system of FIG. 1 illustrating the stages involved in adjusting certain features to change security based on the absence or presence of a user.

FIG. 6 is a process flow diagram for one implementation of the system of FIG. 1 that illustrates the stages involved in adjusting voice-over-IP functionality based on the absence or presence of a user.

FIG. 7 is a process flow diagram for one implementation of the system of FIG. 1 that illustrates the stages involved in adjusting file-sharing functionality based on the absence or presence of a user.

FIG. 8 is a process flow diagram for one implementation of the system of FIG. 1 that illustrates the stages involved in accessing an external attacks service/directory to help determine security adjustments to make based on user presence or absence.

FIG. 9 is a process flow diagram for one implementation of the system of FIG. 1 that illustrates the stages involved in adjusting the operation of one or more applications based on the classification(s) of users present.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that adjusts a system operation based on the presence or absence of a user, but the system also serves other purposes in addition to these. In one implementation, one or more of the techniques described herein can be implemented as features within an operating system such as MICROSOFT® WINDOWS ®, or from any other type of program or service that uses the presence or absence of a user to make adjustments to the operation of one or more applications and/or services on a computing device.

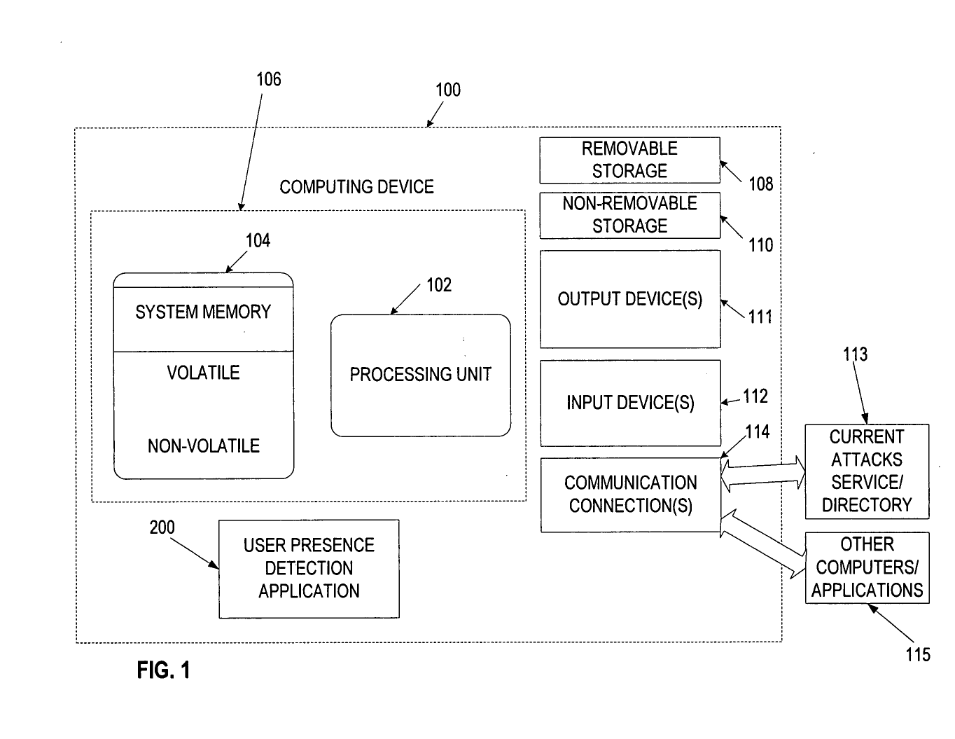

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

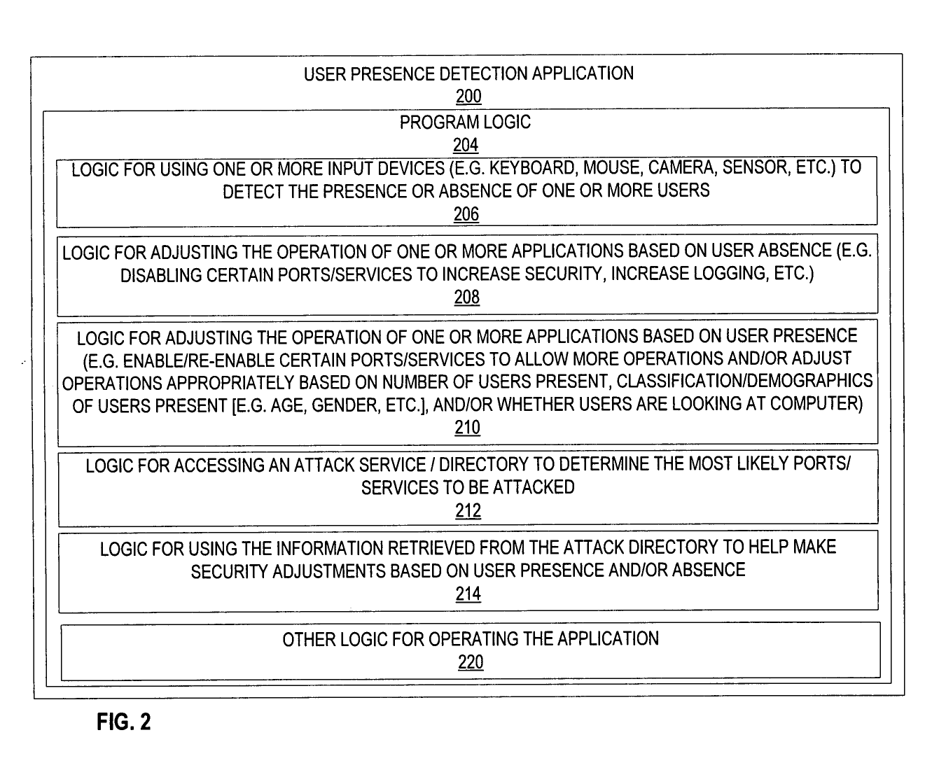

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes user presence detection application 200. In one implementation, user presence detection application 200 communicates with a current attacks service/directory 113 over other communication connection(s) 114. User presence detection application 200 will be described in further detail in FIG. 2.

Turning now to FIG. 2 with continued reference to FIG. 1, a user presence detection application 200 operating on computing device 100 is illustrated. User presence detection application 200 is one of the application programs that reside on computing device 100. However, it will be understood that user presence detection application 200 can alternatively or additionally be embodied as computer-executable instructions on one or more computers and/or in different variations than shown on FIG. 1. Alternatively or additionally, one or more parts of user presence detection application 200 can be part of system memory 104, on other computers and/or applications 115, or other such variations as would occur to one in the computer software art.

User presence detection application 200 includes program logic 204, which is responsible for carrying out some or all of the techniques described herein. Program logic 204 includes logic for using one or more input devices (e.g. keyboard, mouse, camera, sensor, etc.) to detect the presence or absence of one or more users 206; logic for adjusting the operation of one or more applications based on user absence (e.g. disabling certain ports/services to increase security, increase logging, etc.) 208; logic for adjusting the operation of one or more applications based on user presence (e.g. enable/re-enable certain ports/services to allow more operations and/or adjust operations appropriately based on number of users present, class/demographics of users present (e.g. age, gender, etc.), and/or whether users are looking at computer or not) 210; logic for accessing an attack service/directory to determine the most likely ports/services to be attacked 212; logic for using the information retrieved from the attack directory to help make security adjustments based on user presence and/or absence 214; and other logic for operating the application 220. In one implementation, program logic 204 is operable to be called programmatically from another program, such as using a single call to a procedure in program logic 204.

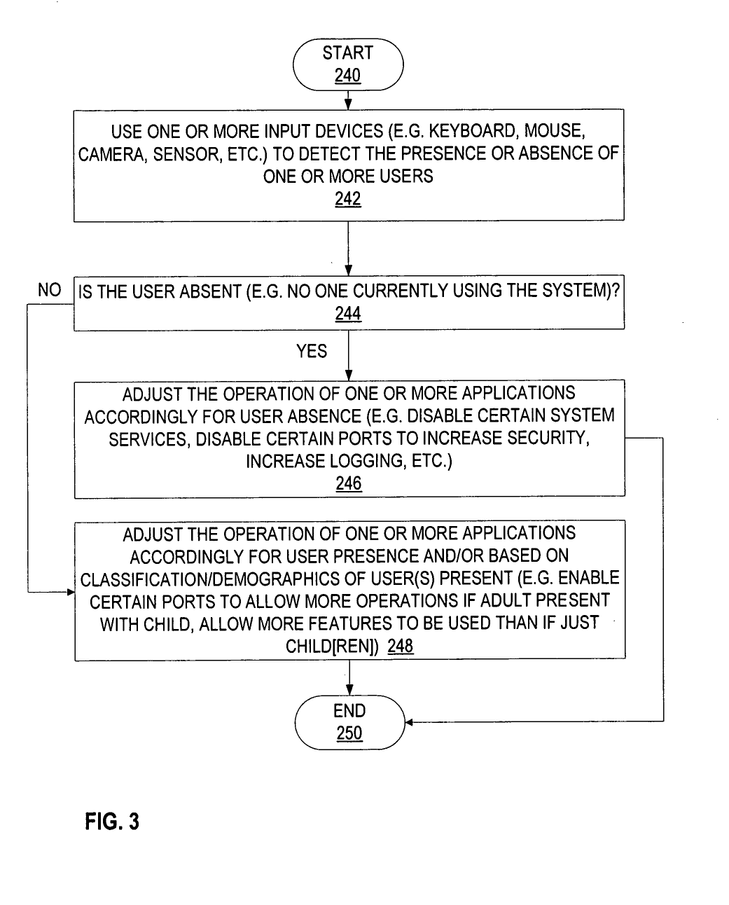

Turning now to FIGS. 3-8 with continued reference to FIGS. 1-2, the stages for implementing one or more implementations of user presence detection application 200 are described in further detail. FIG. 3 illustrates one implementation of the stages involved in detecting the presence or absence of one or more users and adjusting the security and/or other system features accordingly. In one form, the process of FIG. 3 is at least partially implemented in the operating logic of computing device 100.

The procedure begins at start point 240 with using one or more input devices (e.g. keyboard, mouse, camera, sensor, etc.) to detect the presence or absence of one or more users (stage 242). Is the user absent (e.g. no one currently using the system) (decision point 244), then the system adjusts the operation of one or more services and/or applications accordingly for user absence (e.g. disables certain system services, disables certain ports to increase security, increases logging, etc.) (stage 246). If one or more users are present (e.g. the user is not absent) (decision point 244), then the system adjusts the operation of one or more applications accordingly for user presence and/or based on classification/demographics of user(s) present (e.g. enables certain ports to allow more operations if an adult is present with a child, allows more features to be used than if just one or more children present, etc.) (stage 248). The process ends at end point 250.

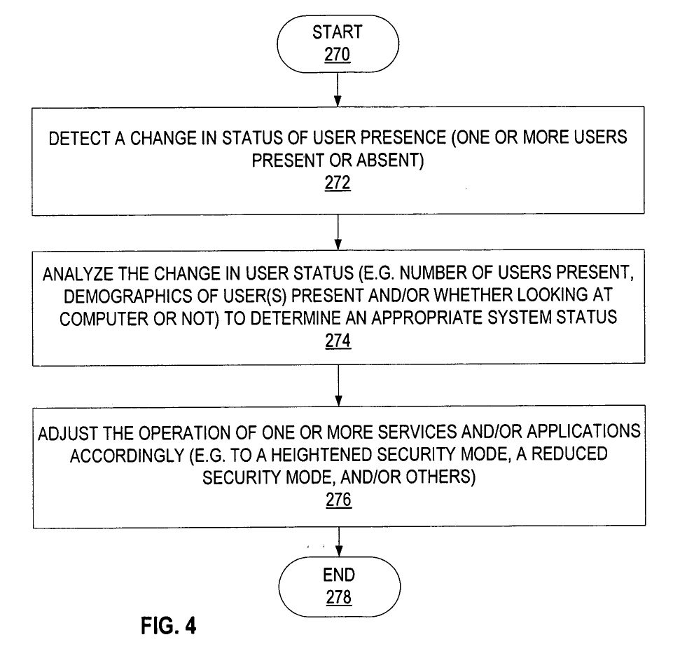

FIG. 4 illustrates one implementation of the stages involved in detecting the presence or absence of one or more users. In one form, the process of FIG. 4 is at least partially implemented in the operating logic of computing device 100. The procedure begins at start point 270 with detecting a change in the status of a user's presence (one or more users present or absent) (stage 272). The changes in the user(s) status are analyzed (e.g. the number of users present, demographics of user(s) present and/or whether they are looking at the computer or not) (stage 274). The operation of one or more applications is adjusted accordingly (e.g. system switched to a heightened security mode, a reduced security mode, and/or others) (stage 276). The process ends at end point 278.

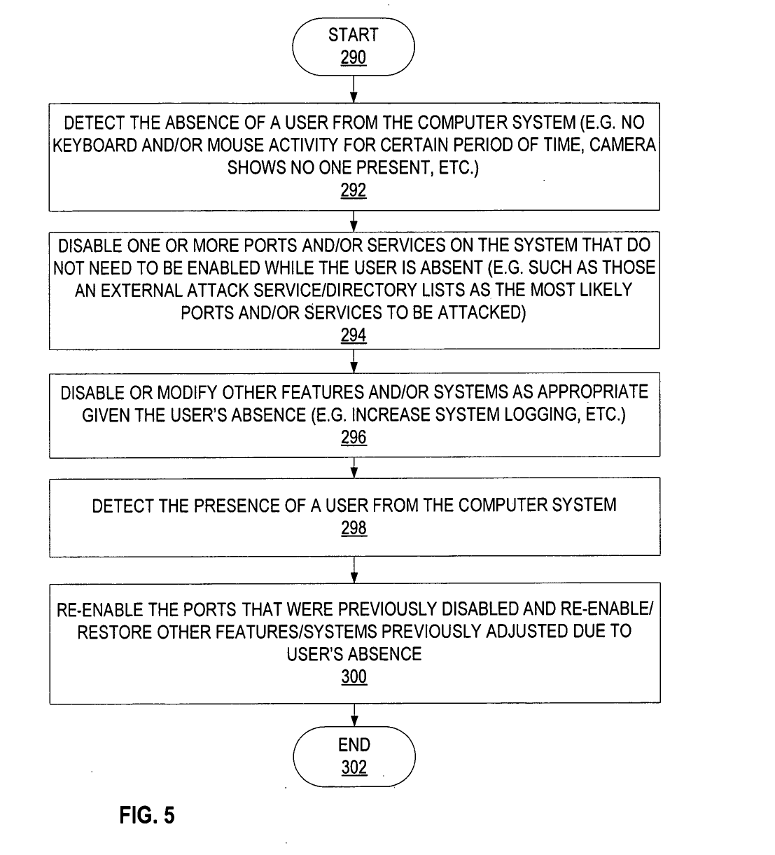

FIG. 5 illustrates one implementation of the stages involved in adjusting certain features to change security based on the absence or presence of a user. In one form, the process of FIG. 5 is at least partially implemented in the operating logic of computing device 100. The procedure begins at start point 290 with detecting the absence of a user from the computer system (e.g. no keyboard and/or mouse activity for a certain period of time, camera shows no one present, etc.) (stage 292). The system disables one or more ports and/or services on the system that do not need to be enabled while the user is absent (e.g. such as those an external attack service/directory lists as the most likely ports and/or services to be attacked) (stage 294). Other features and/or systems are disabled and/or modified as appropriate given the user's absence (e.g. increase system logging, etc.) (stage 296). The presence of a user is detected from the computer system (e.g. the user returned, or a different user comes) (stage 298). The ports and/or services that were previously disabled are re-enabled and other features/systems previously adjusted due to user's absence are also restored (stage 300). The process ends at end point 302.

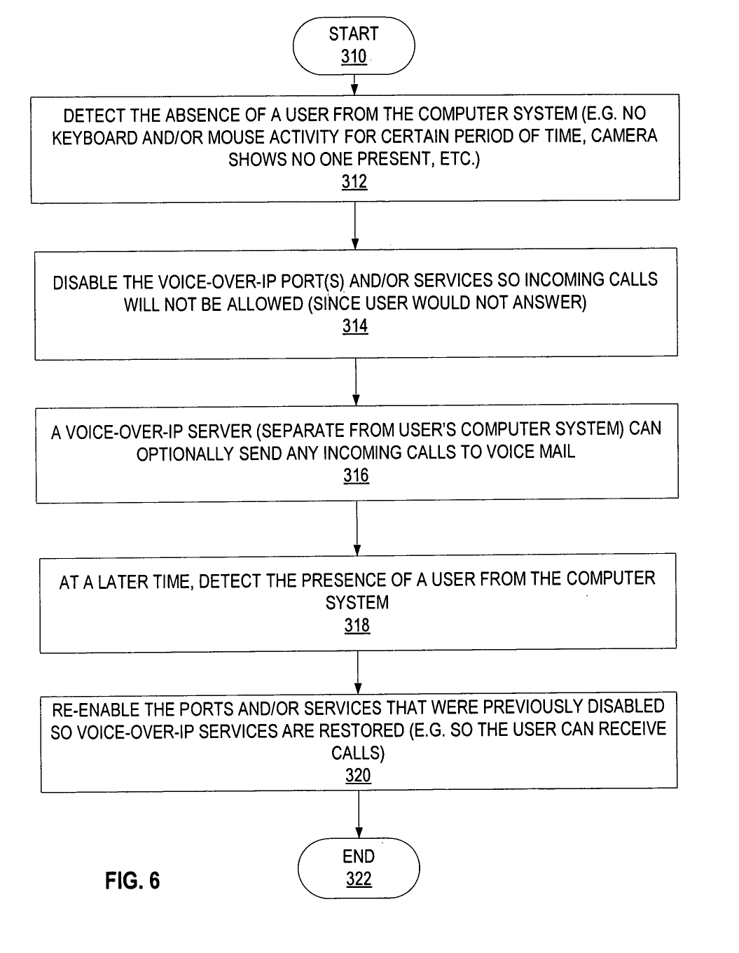

FIG. 6 illustrates one implementation of the stages involved in adjusting voice-over-IP functionality based on the absence or presence of a user. In one form, the process of FIG. 6 is at least partially implemented in the operating logic of computing device 100. The procedure begins at start point 310 with detecting the absence of a user from the computer system (e.g. no keyboard and/or mouse activity for a certain period of time, camera shows no one present, etc.) (stage 312). The voice-over-IP port(s) and/or services are disabled so incoming calls will not be allowed (since user would not answer) (stage 314). A voice-over-IP server (separate from user's computer system) can optionally send any incoming calls to voice mail (stage 316). At a later time, the presence of a user is detected from the computer system (stage 318). The ports and/or services that were previously disabled are re-enabled so voice-over-IP services are restored (e.g. so the user can receive calls) (stage 320). The process ends at end point 322.

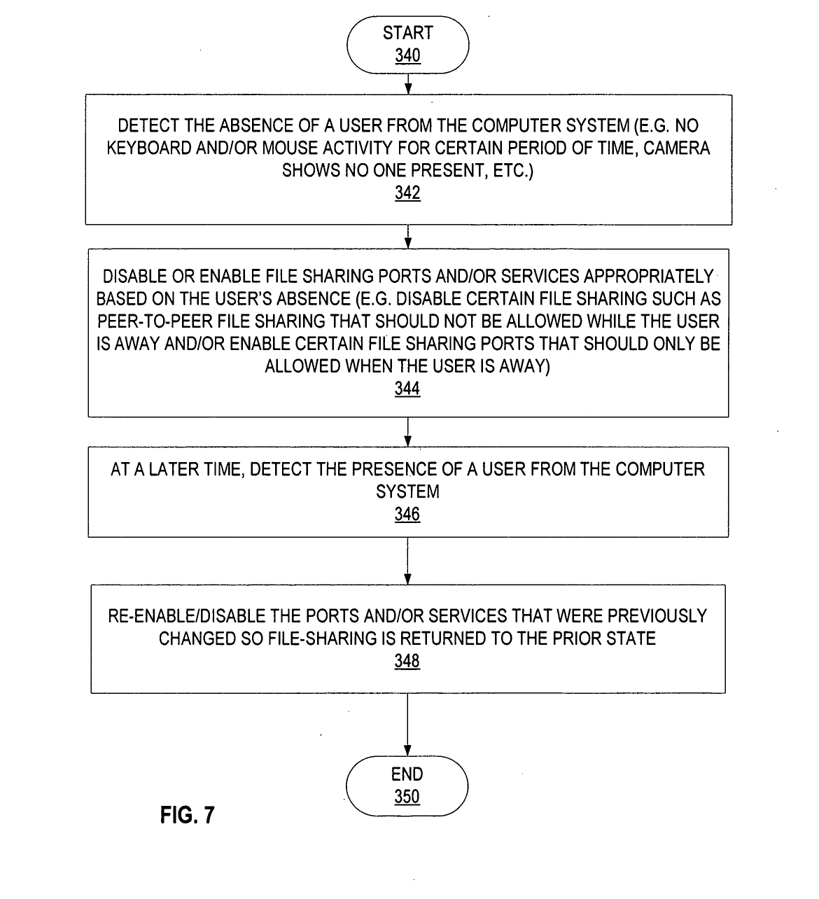

FIG. 7 illustrates one implementation of the stages involved in adjusting file-sharing functionality based on the absence or presence of a user. In one form, the process of FIG. 7 is at least partially implemented in the operating logic of computing device 100. The procedure begins at start point 340 with detecting the absence of a user from the computer system (e.g. no keyboard and/or mouse activity for a certain period of time, camera shows no one present, etc.) (stage 342). Certain file sharing ports and/or services are disabled or enabled appropriately based on the user's absence (stage 344). As a few non-limiting examples, the system may disable certain file sharing such as peer-to-peer file sharing that should not be allowed while the user is away, and/or the system may enable certain file sharing ports that should only be allowed when the user is away (e.g. for external access to the data) (stage 344). At a later time, the presence of a user is detected from the computer system (stage 346). The ports and/or services that were previously changed are re-enabled or disabled accordingly so file-sharing is returned to the prior state (stage 348). The process ends at end point 350.

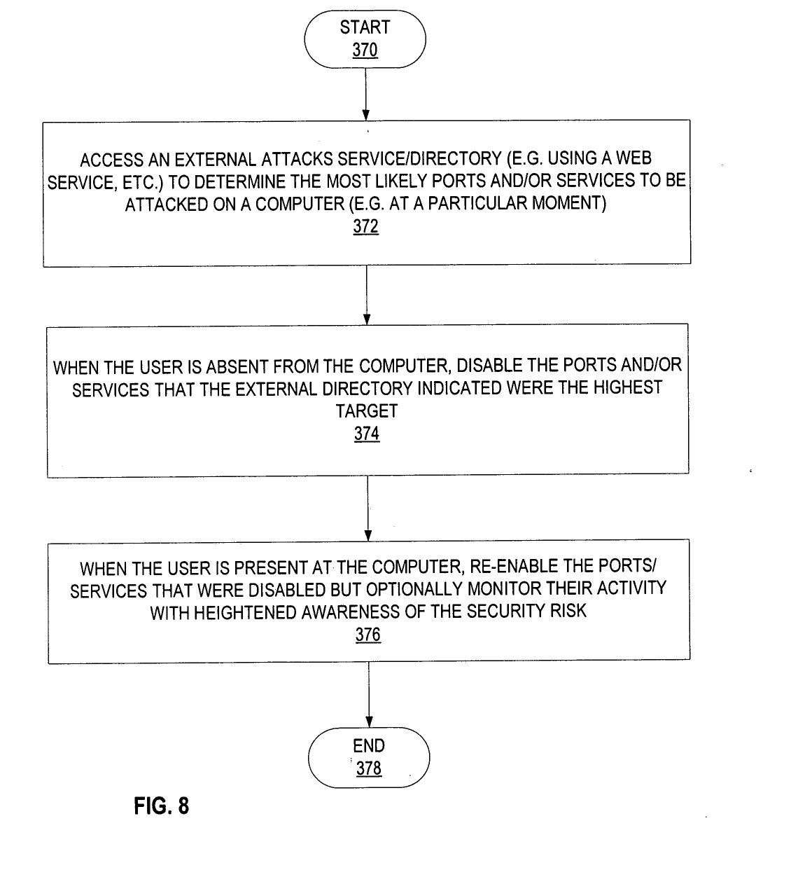

FIG. 8 illustrates one implementation of the stages involved in accessing an external attacks service/directory to help determine security adjustments to make based on user presence or absence. In one form, the process of FIG. 8 is at least partially implemented in the operating logic of computing device 100. The procedure begins at start point 370 with accessing an external attacks service/directory (e.g. using a web service, etc.) to determine the most likely ports and/or services to be attacked on a computer (e.g. at a particular moment) (stage 372). When the user is absent from the computer, the ports and/or services that the external directory indicated were the highest targets are disabled (stage 374). When the user is present at the computer, the system re-enables the ports and/or services that were disabled, but optionally monitors their activity with heightened awareness of the security risk (stage 376). The process ends at end point 378.

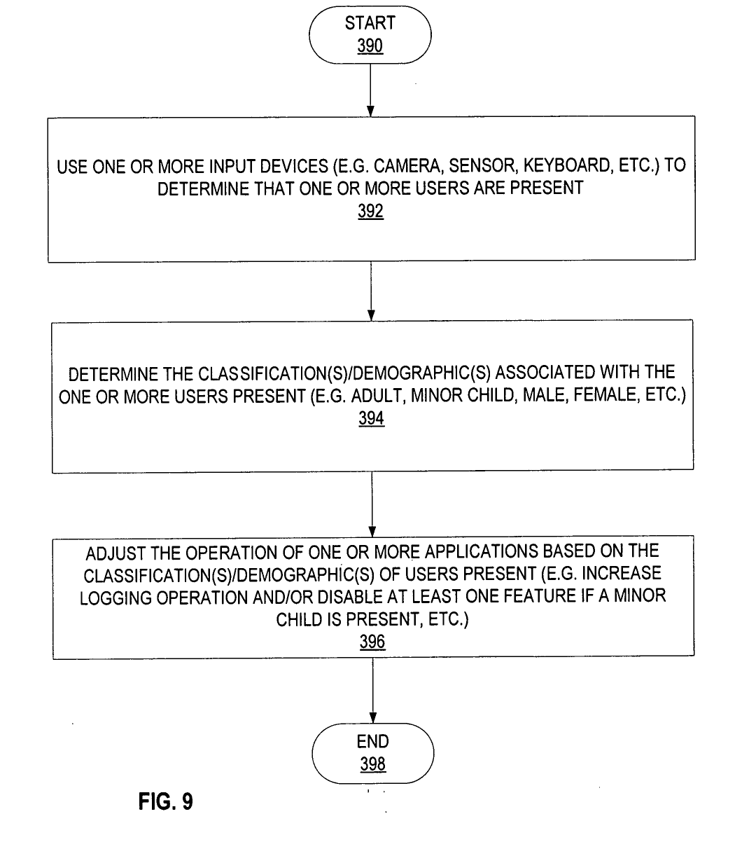

FIG. 9 illustrates one implementation of the stages involved in adjusting the operation of one or more applications based on the classification(s) of users present. In one form, the process of FIG. 9 is at least partially implemented in the operating logic of computing device 100. The procedure begins at start point 390 with using one or more input devices (e.g. camera, sensor, keyboard, etc.) to determine that one or more users are present (stage 392). The system determines the classification(s)/demographic(s) associated with the one or more users present (e.g. adult, minor child, male, female, etc.) (stage 394). The operation of one or more applications is adjusted based on the classification(s)/demographic(s) of users present (stage 396). As a few non-limiting examples, the system can increase a logging operation and/or disable at least one feature of one or more applications if a minor child is present, etc. (stage 396). The process ends at end point 398.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for enhancing security of a computer when a user is detected to be absent comprising the steps of:
detecting an absence of a user from a computer system; and
disabling at least one system port or service on the computer system that does not need to be enabled while the user is absent to increase a security state of the computer system.

2. The method of claim 1, further comprising:
accessing an external attack service to retrieve a most likely list of one or more services to be attacked on the computer system.

3. The method of claim 2, wherein the at least one system port or service disabled is at least in part based upon the list retrieved from the external attack service.

4. The method of claim 2, wherein the external attack service is accessed using a web service.

5. The method of claim 2, wherein the external attack service provides access to information about attacks that are most likely to happen at a current moment.

6. The method of claim 1, wherein the at least one system port or service disabled is a file-sharing port.

7. The method of claim 1, wherein the at least one system port or service disabled is a voice-over-IP port.

8. The method of claim 1, wherein the absence of the user is detected from a period of inactivity on an input device.

9. The method of claim 1, wherein the absence of the user is detected using a camera.

10. The method of claim 1, wherein the absence of the user is detected using a sensor.

11. A computer-readable medium having computer-executable instructions for causing a computer to perform the steps recited in claim 1.

12. A computer-readable medium having computer-executable instructions for causing a computer to perform steps comprising:
use at least one input device to detect whether one or more users are present;
access an attack directory to retrieve information that includes at least one most likely service to be attacked; and
use at least part of the information retrieved from the attack directory along with the detection of whether one or more users are present to make at least one adjustment to a system operation.

13. The computer-readable medium of claim 12, further having computer-executable instructions for causing a computer to perform the step comprising:
detect that the user is absent.

14. The computer-readable medium of claim 13, further having computer-executable instructions for causing a computer to perform steps comprising:
upon detecting that the user is absent, use at least part of the information retrieved from the attack service to determine a service to disable.

15. A method for adjusting the operation of a computer based on a classification of a user present comprising the steps of:
using at least one input device to detect that at least one user is present;
determining a classification associated with the at least one user present; and
adjusting an operation of at least one application based on the classification of the at least one user present.

16. The method of claim 15, wherein the classification of the user is a minor child.

17. The method of claim 16, wherein the operation includes increasing a logging action for the at least one application.

18. The method of claim 16, wherein the operation includes disabling at least one feature in the at least one application.

19. The method of claim 15, wherein the input device is a camera.

20. A computer-readable medium having computer-executable instructions for causing a computer to perform the steps recited in claim 15.
